(19) United States
(12) Patent Application Publication
(10) Pub. No.: US 2003/0131447 A1
(43) Pub. Date: Jul. 17, 2003

(54) Bag grip for carrying multiple plastic bags

(76) Inventor: David A. Mikus, Bell Buckle, TN (US)

Correspondence Address: Richard C. Litman, LITMAN LAW OFFICES, LTD., P.O. Box 15035, Arlington, VA, 22215, US

(21) Appl. No.: 10/046,084

(22) Filed: Jan. 16, 2002

(51) Int. Cl. E05B 1/00

(52) U.S. Cl. 16/422

(57) ABSTRACT

The bag grip is utilized to grip and carry one or more plastic grocery or shopping bags. The bag grip folds over the bag handles for easier carrying of one or more plastic bags and prevents the bags from opening, tearing and cutting or cutting off the circulation in the user's hand. The grip is a trifold with a substantially oval shape having a rectangular center section with foldable, semicircular wings on opposite sides of the center section. The grip has neoprene front and back covers with a substantially rectangular neoprene cushioning pad in the center section. Each of the semicircular wings has hook and loop fastening material attached thereto so that the grip can be temporarily fastened around the loop handles of the plastic bag(s). Advertisement and instructional indicia may be provided on the center section of the grip.

### BACKGROUND OF THE INVENTION

1. Field of the Invention

The present invention relates generally to bag handle attachments. More specifically, the invention is a cushioned, double-sided, tri-folding neoprene pad for carrying and/or storing one or more plastic bags and multiple bunched bags.

2. Description of Related Art

The related art of interest describes various types of accessory pads for bag handles, tools and the like, but none discloses the present invention. There is a need for carrying a plurality of plastic bags with loop handles with one grip while avoiding the risk of tearing the plastic bag handle portions. Frequently the weight of articles contained in a plastic bag causes the loop handle on the bag to become taut and cut into the palm of the hand, or into the joints of the fingers, which can be uncomfortable and even painful if the bags must be held for an extended length of time. Further, plastic bags with loop handles often have no closure means, so that when the bags are set down on a car seat or in the trunk of a vehicle, the contents spill out of the bag. There is a need for a cushioned handle with convenient, quick release fastening means for gripping the loop handles of plastic bags. It would further be desirable to have a bag grip which can be used with a group of plastic bags, so that the grouped bags can be stored in the trunk of a car and carried into the house as such. The related art will be discussed in the order of perceived relevance to the present invention.

U.S. Pat. No. 5,487,582 issued on Jan. 30, 1996, to Barbara S. Bourgeois et al. describes a detachable shopping bag handle comprising a flexible member made of woven cotton in a quilt pattern enclosing a padded portion, an external denim pocket, an eyelet for a keyring, perimeter binding, and two strips of hook and loop fastening on its edges. The device is distinguishable for requiring different materials, an external pocket, and perimeter binding.

U.S. Pat. No. 4,262,385 issued on Apr. 21, 1981, to Bill Norman describes an hourglass-shaped weight-cushioning handle device for carrying a bowling ball bag comprising an outer layer of a fabric backed vinyl and an inner layer of a foam cushioning material. A cloth trim around the peripheral edge of the device is stitched on. A rectangular hook layer strip and a loop layer strip are sewn onto opposite sides and opposite ends of the device. The device is distinguishable for requiring an hourglass-shaped handle with a fabric cover and a foam insert.

U.S. Design Pat. No. 317,246 issued on Jun. 4, 1991, to Robert J. Driscoll describes an ornamental handle for shopping bags shaped like a rounded rolling pin with hook and loop fastening strips on opposite ends. The ornamental handle is distinguishable for its shape and the location of the hook and loop fasteners on the same side.

U.S. Pat. No. 2,274,605 issued on Feb. 24, 1942, to Roy Hoffineister describes a zippered gripping pad for suitcase handles comprising a notched rubber pad with an inner sponge rubber layer. The opposite longitudinal edges have a zipper and zipper fastening tape attached. The pad device is distinguishable for requiring a zipper fastener and a notched rubber pad.

U.S. Pat. No. 3,800,361, issued on Apr. 2, 1974, to Rita A. Stauffer describes a hand saver device for carrying shopping bags and cartons having cord handles, comprising a U-shaped, channeled foam rubber or plastic foam body. The device is distinguishable for requiring a channeled foamed body.

U.S. Pat. No. 5,364,148 issued on Nov. 15, 1994, to Anna Bartocci describes a grip device for carrying shopping bags with flexible handles comprising a tubular grip member formed from an inner core of a sponge or rubber enclosing a rigid organic polymeric material or wood, and having an upper longitudinal slot and cavity in the sponge layer. The core is covered with a fabric sheath and secured at the bottom by velcro strips. A complete fabric cover over the fabric sheath is optional. The device is distinguishable for requiring a sponge and rigid insert with a covering of one or more fabric materials.

U.S. Design Pat. No. 380,382 issued on Jul. 1, 1997, to Claudia H. Rhone et al. describes an ornamental plastic bag holder comprising an elongated, substantially rectangular layer with rounded ends having opposing slots for engagement to hold onto a plastic bag with solid handles. The planar device is distinguishable for requiring only a single layer with opposing slots.

U.S. Pat. No. 4,754,858 issued on Jul. 5, 1988, to Mark Robinson describes a cushioning pad for handheld luggage handles and garment bags comprising a rectangular polyvinyl chloride foam pad having holes at each end for tying elastic cords for attaching the pad to a suitcase handle, to a shoulder strap of a luggage, or around a plurality of hangers in a garment bag. The pad is distinguishable for requiring only a sponge pad and end ties.

U.S. Pat. No. 4,682,691 issued on Jul. 28, 1987, to Johan R. Spiering describes a roll-up velcro tool holder comprising a rectangular sheet of nylon having a pair of parallel velcro hook strips on an inner surface and a pair of parallel velcro loop strips on the outside surface. A nylon handle strip is attached to the outside surface. The tools are rolled up and the velcro patches secured together to form a bundle with a handle. The device is distinguishable for requiring the parallel strips of hook and loop material and a handle.

U.S. Pat. No. 3,941,159 issued on Mar. 2, 1976, to Wolcott Toll describes an insulation assembly for a tubular conduit pipe comprising an insulation layer on a pipe wrapped with a fabric layer having hook and loop on opposite sides of opposite ends. The insulation assembly is distinguishable for being limited to pipes.

U.S. Pat. No. 5,083,825 issued on Jan. 28, 1992 to Benjamin L. Bystrom et al. describe a cylindrical hinged handle for a bag or bag carrier comprising a rigid inner core of either metal, plastic, wood, ceramic, cermet, hard rubber or the like which is split longitudinally. The outer shell can be one- or two-piece elastomeric material (unnamed) having strips of interlocking hook and loop fastening strips on opposite sides and ends. The devices are distinguishable for requiring a rigid core and an elastomeric one- or two-piece cylindrical shell.

U.S. Pat. No. 5,651,575 issued on Jul. 29, 1997, to Andrew P. Bystrom et al. describes a cylindrical two-piece hollow hinged bag carrier handle comprising a wood, metal or plastic shell having a hook and notch locking mechanism on its upper ends, and hinged on its bottom ends by an elastomeric hinge. The handle is distinguishable for requiring a two-piece hinged and locking handle.

U.S. Pat. No. 6,065,764 issued on May 23, 2000, to Christine M. Moseley describes a reusable sanitary cover for a shopping cart handle comprising a cylindrical washable sheet having a slit and decorated for a child's benefit. Alternatively, two transparent sheets having snap members secure the cover to the shopping cart handle. The handle covers are distinguishable for requiring cylindrical sheets.

U.S. Pat. No. 5,387,684 issued on Sep. 20, 1994, to Linda J. Jackson describes a flexible sheet cover for a grip of a tool, cooking utensil and the like implement comprising a foamed rubber sheet made in two parts to fit a handle by hook and loop fastening and a portion of the tool's body secured by an elastic band. Another embodiment for a screwdriver handle employs a rectangular sheet secured by hook and loop fastening. The grip cover device is distinguishable for its singular layer of foamed rubber.

U.K. Patent Application No. 2 135 179 A published on Aug. 30, 1984, for Leonel H. Machado et al. describes a detachable plastic handgrip for carrying items such as plastic bags, comprising an elongate tubular body having opposing sidewalls and a separable top portion. The handgrip is distinguishable for requiring a flexible one-piece plastic device having a specific configuration.

U.K. Patent Application No. 2 153 213 A published on Aug. 21, 1985, for Patrick J. Garvey describes a detachable interior-bearing and load-bearing handle for carrying bags with wire, string, cord, band, strap or sheet handles comprising a cylindrical hollow body with a thin longitudinal gap either in a straight line or grooved on top, finger depressions on the bottom surface, and open ends. A transverse bolt or clasp can be used on top for securing the open slit. The handle is distinguishable for its one-piece structure.

U.K. Patent Application No. 2 228 860 A published on Sep. 12, 1990, for Timothy Bradstock-Smith describes a detachable multiple bag carrier handle comprising a resilient plastic hollow tube having a split top portion, widenings at both ends, and indentations on the bottom for fingers. The handle is distinguishable for its singular structure.

None of the above inventions and patents, taken either singly or in combination, is seen to describe the instant invention as claimed.

### SUMMARY OF THE INVENTION

The bag grip is utilized to grip and carry one or more plastic grocery or shopping bags. The bag grip folds over the bag handles for easier carrying of one or more plastic bags and prevents the bags from opening, tearing and cutting or cutting off the circulation in the user's hand. The grip is a trifold with a substantially oval shape having a rectangular center section with foldable, semicircular wings on opposite sides of the center section. The grip has neoprene front and back covers with a substantially rectangular neoprene cushioning pad in the center section. Each of the semicircular wings has hook and loop fastening material attached thereto so that the grip can be temporarily fastened around the loop handles of the plastic bag(s). Advertisement and instructional indicia may be provided on the center section of the grip.

Accordingly, it is a principal object of the invention to provide a bag grip having a foldable trifold shape for carrying a plurality of plastic grocery or shopping bags.

It is another object of the invention to provide a bag grip which prevents the plastic bag handles from tearing or injuring the carrier's hand, or by cutting off circulation in the hand, by including padding in the grip.

It is a further object of the invention to a bag grip having hook and loop fastening material as closure means for fastening the grip around the bag handles.

Still another object of the invention is to provide advertisement and instructional indicia on the inner surface of the device.

It is an object of the invention to provide improved elements and arrangements thereof in an apparatus for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental, perspective view of a bag grip for carrying multiple plastic bags according to the present invention shown wrapped around the handles of a plurality of plastic bags.

FIG. 2A is a top plan view of the bag grip showing the hook fastener ends.

FIG. 2B is a schematic cross-sectional view of the length dimension of the bag grip according to the present invention.

FIG. 3A is a bottom plan view of the bag grip showing the opposite side having loop fastener ends.

FIG. 3B is a schematic cross-sectional view of the width dimension of the bag grip according to the present invention.

FIG. 4A is a top plan view of a bag grip according to the present invention having an advertisement logo.

FIG. 4B is a bottom plan view of the grip having instructional indicia on how to use the device in carrying multiple plastic bags.

Similar reference characters denote corresponding features consistently throughout the attached drawings.

### DETAILED DESCRIPTION OF THE PREFERRED EMBODIMENT

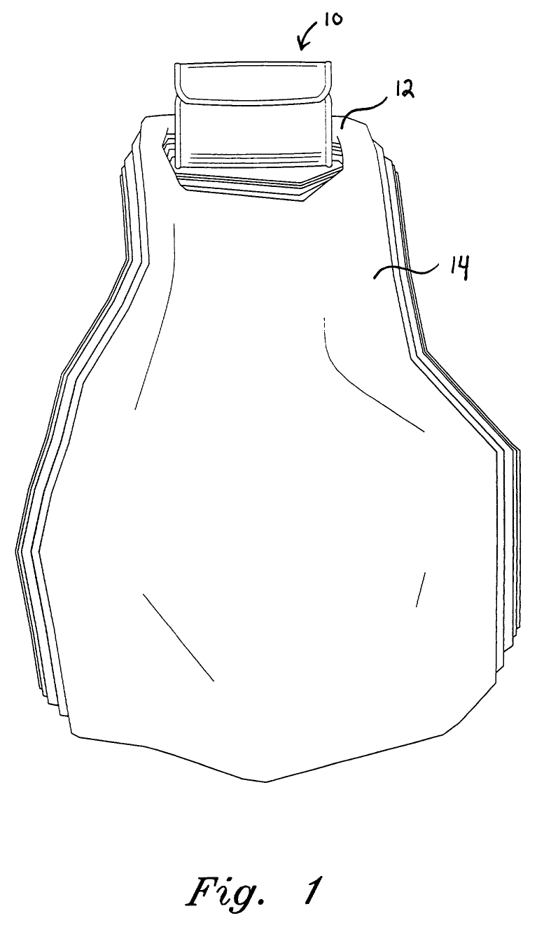

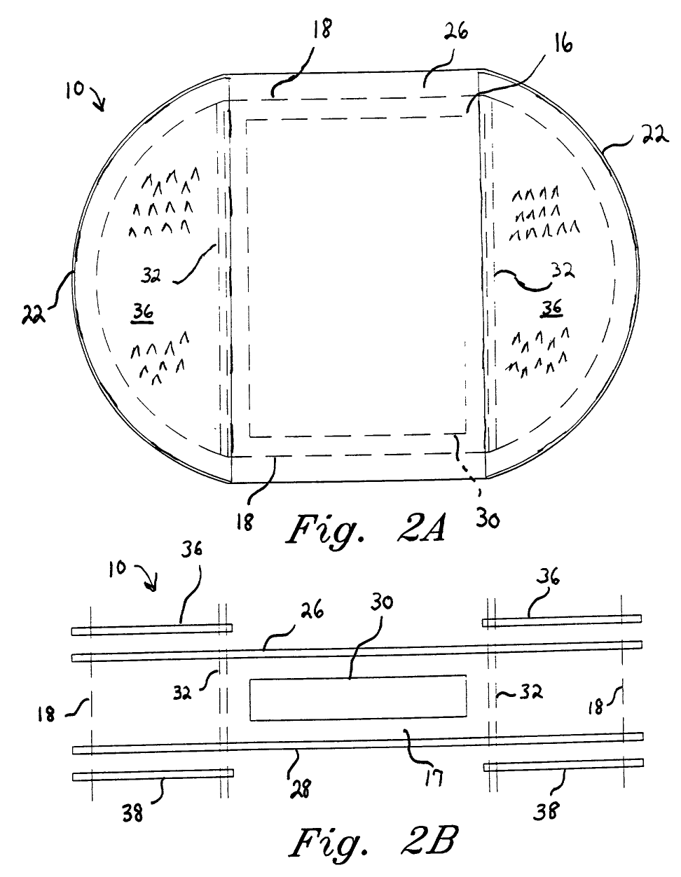

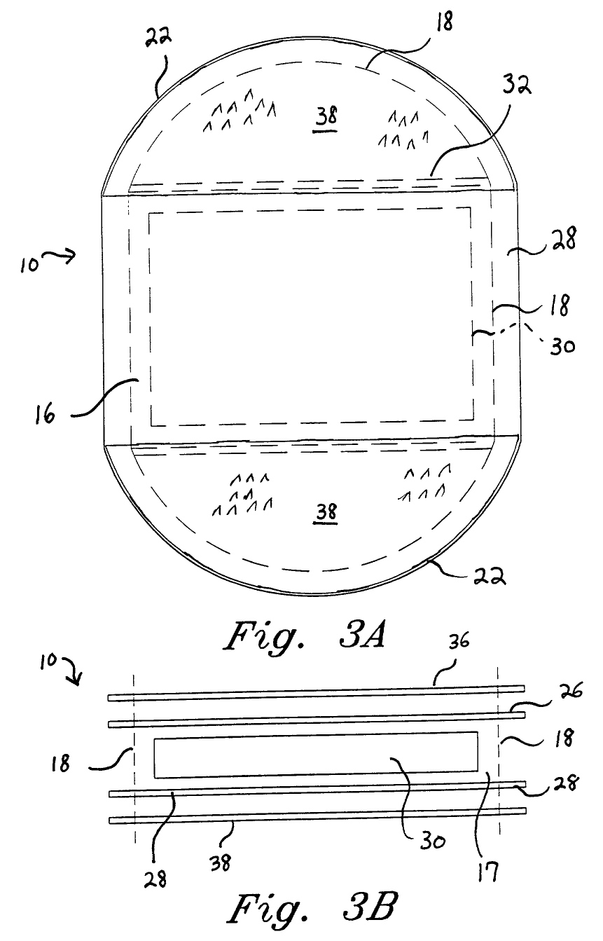

The present invention is directed in FIG. 1 to a bag grip 10 for carrying multiple plastic bags attached to the loop handles 12 of a plurality of plastic bags 14. As illustrated in FIGS. 2A, 2B, 3A, and 3B, the bag grip 10 comprises a substantially oval shaped structure having a top cover 26 and a bottom cover 28 which are preferably made from flexible neoprene material. Stitching defines a substantially rectangular center section 16 generally indicated by the single line stitching 18 which joins the top cover 26 to the bottom cover 28 about the periphery of the grip 10, and by the parallel double line stitching 32. Although stitching is shown, it is also within the ambit of the invention to utilize heated fabric glue or other fastening means in lieu of stitching. The double stitching 32 defines a pair of outer, approximately semicircular, foldable wings 22 disposed on opposite sides of the center section 16. A die cut rectangular neoprene pad 30 for padding or cushioning is disposed in the rectangular center section 16 and floats in a pocket 17 defined by the stitching.

The top layer 26 and the bottom layer 28 are sewn together with single stitching 18 of upholstery thread, while the intersections between the rectangular inner portion 16 and the outer semicircular portions 22 are sewn with double stitching 34 of upholstery thread, defining the fold lines of the trifold structure. The pocket 17 in the center section 16 for the rectangular neoprene pad 30 is defined by single stitching 18 proximate the edges of the grip 10 and by double stitching 32 proximate the wings 22. The stitching pattern gives the bag grip 10 a trifold form which collapses easily around the loop handles of the plastic bags 14.

A die cut hook fastening layer or patch 36 is disposed on each wing portion 22 of top cover 26 substantially coextensive with the area of the wing 22. A die cut loop fastening layer or patch 38 is disposed on each wing portion 22 of bottom cover 28, preferably substantially coextensive with the area of the wing 22. The positioning of the hook patches 36 on the top cover 26 is critical, because the hook patches 36 are covered by the loop patches 38 to prevent irritation from exposed hook patches 38 when secured together on the bag handles 12. Disposing hook and loop fastening material on both sides of each wing 22 means that the grip can be fastened by folding either wing 22 over the other. The large surface area of the patches 36 and 38 has the advantage of making the fasteners continuously adjustable, depending on the number of loop handles 12 grasped. Alternatively, one hook and loop fastener patch can be placed on one wing area of top cover 26 and the other, mating patch may be fastened to the wing area of the bottom cover 28 on the opposite side of center section 16 so that the user need not grasp any hook and loop material while using the grip 10.

A plurality of plastic bags 14 can be grasped and carried by wrapping and securing the bag grip 10 around the handle portions 12 of the plurality of plastic bags 14 for portage or storage. It should be noted that the bag grip 10 is equally applicable to carrying multiple shopping bags having cord handles to prevent the hands from becoming irritated or painful, and to keep the secured bags together in storage or in conveyance.

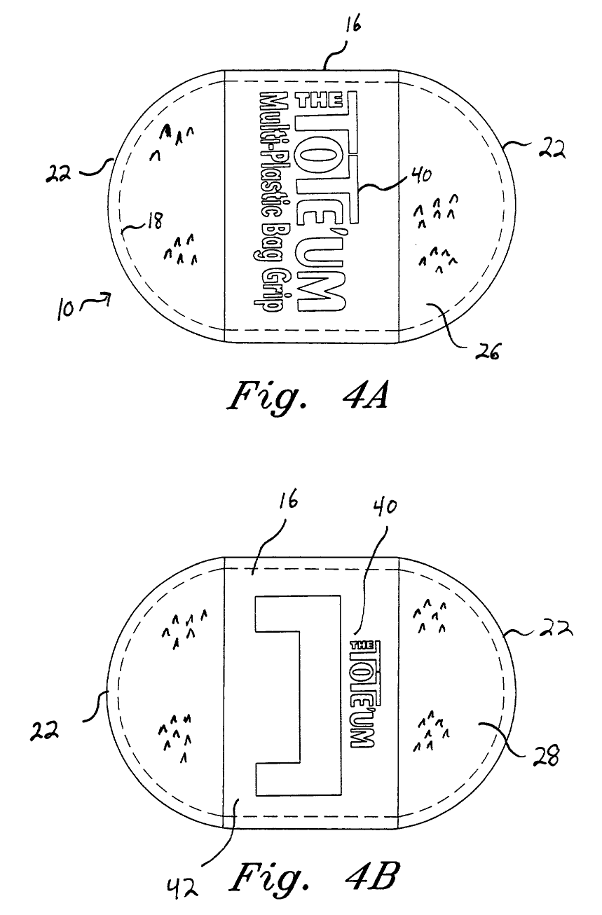

As illustrated in FIGS. 4A and 4B, advertising or other indicia 40 can be incorporated on the center section 16 of the top cover 26, either by imprinting or by adhering a printed label. As illustrated in FIG. 4B, the center section 16 of the bottom cover 28 provides additional space for indicia 40. The grip 10 may have exposed white nylon facing 42 attached thereto for imprinting indicia or attaching labels on the grip 10.

The advantages of utilizing these multi-plastic bag grip devices 10 are that several plastic bags 14 can be bundled with their handles fastened together while transporting the bags to a destination, such as home, and then carried into the house. Moreover, several bundles can be gathered together to transport them to the destination, thus minimizing the number of handles to grab.

Another important advantage lies in the fact that the bag grip 10 because the grip 10 may be used by either a right- or a left-handled person due to positioning of the hook and loop fastening material on both sides of the cover on both wings of the trifold.

Exemplary dimensions of the bag handle accessory pad 10 are as follows:

Length: 6 in.

Width: 4 in.

Rectangular inner portion 16: 2½ in. width, 4 in. length.

Wings 22: 4 in. diameter, 1¾ in. radius.

Neoprene padding 30: 2⅛ in. width, 3¼ in. length, 6 mm. thick, die cut, black color.

It is to be understood that the present invention is not limited to the sole embodiment described above, but encompasses any and all embodiments within the scope of the following claims.

I claim:

1. A bag grip for carrying multiple plastic bags, comprising:
a top cover having a substantially oval shape;
a bottom cover having a substantially oval shape, the bottom cover being joined to the top cover about the periphery of the covers;
joining means for joining the top cover to the bottom cover in order to define a substantially rectangular center section defining a pocket and a first substantially semicircular wing on one side of the center section and a second substantially semicircular wing on an opposite side of the center section;
a cushioning pad disposed in said pocket; and
fastening means disposed on said first and second wings to form a trifold article, whereby the bag grip is adapted for folding about loop handles of plastic bags for cushioning a user's grip on the bags and for fastening the bags.

2. The bag grip for carrying multiple plastic bags according to claim 1, wherein the top cover and the bottom cover are-made from neoprene.

3. The bag grip for carrying multiple plastic bags according to claim 1, wherein said joining means comprises a double row of upholstery thread stitching.

4. The bag grip for carrying multiple plastic bags according to claim 1, wherein said joining means comprises adhesive.

5. The bag grip for carrying multiple plastic bags according to claim 1, wherein said cushioning pad comprises a neoprene pad.

6. The bag grip for carrying multiple plastic bags according to claim 1, further comprising indicia imprinted on the center section of said cover.

7. The bag grip for carrying multiple plastic bags according to claim 1, further comprising exposed nylon facing on the center section of the grip for printing indicia.

8. The bag grip for carrying multiple plastic bags according to claim 1, wherein said fastening means comprises hook and loop fastening material.

9. The bag grip for carrying multiple plastic bags according to claim 1, wherein said fastening means comprises at least one patch of hook and loop fastening material attached to said first wing and at least one second patch of hook and loop fastening material attached to said second wing.

10. The bag grip for carrying multiple plastic bags according to claim 9, wherein said first and second patches of hook and loop fastening material are coextensive in area to said first and second wings, whereby said fastening means is continuously adjustable.

11. The bag grip for carrying multiple plastic bags according to claim 1, wherein said fastening means comprises a pair of hook fastening patches attached to the first and second wings of said top cover, respectively, and a pair of loop fastening patches attached to the first and second wings of said bottom cover, respectively.

12. A bag grip for carrying multiple plastic bags, comprising:
a top cover having a substantially oval shape;
a bottom cover having a substantially oval shape, the bottom cover being joined to the top cover about the periphery of the covers;
a pair of spaced apart double rows of stitching joining the top cover to the bottom cover in order to define a substantially rectangular center section defining a pocket and a first substantially semicircular wing on one side of the center section and a second substantially semicircular wing on an opposite side of the center section;
a cushioning pad disposed in said pocket; and
a pair of hook fastening patches attached to the first and second wings of said top cover, respectively, and a pair of loop fastening patches attached to the first and second wings of said bottom cover, respectively, to form a trifold article, whereby the bag grip is adapted for folding about loop handles of plastic bags for cushioning a user's grip on the bags and for fastening the bags.
